(19) United States
(12) Patent Application Publication
(10) Pub. No.: US 2025/0279834 A1
(43) Pub. Date: Sep. 4, 2025

(54) STATION-SIDE OPTICAL NETWORK UNIT, COMMUNICATION SYSTEM, AND CONTROL METHOD

(71) Applicant: NIPPON TELEGRAPH AND TELEPHONE CORPORATION, Tokyo (JP)

(72) Inventors: Sang-Yuep KIM, Musashino-shi (JP); Junichi KANI, Musashino-shi (JP)

(73) Assignee: NIPPON TELEGRAPH AND TELEPHONE CORPORATION, Tokyo (JP)

(21) Appl. No.: 18/857,445

(22) PCT Filed: Apr. 28, 2022
(86) PCT No.: PCT/JP2022/019379

§ 371 Date: Oct. 16, 2024

(51) Int. Cl. H04B 10/564; H04B 10/079

(52) U.S. Cl. CPC H04B 10/564; H04B 10/07953

(57) ABSTRACT

An aspect of the present invention is a station-side optical network unit to be connected to a subscriber-side optical network unit, the station-side optical network unit including: an acquisition unit that acquires, from the subscriber-side optical network unit, a signal-to-noise ratio of a received signal transmitted from the station-side optical network unit and received by the subscriber-side optical network unit; a deriving unit that derives a physical quantity indicating a quality of the received signal from the signal-to-noise ratio acquired by the acquisition unit; and a setting unit that sets a power of a signal transmitted by the station-side optical network unit to a minimum power among powers at which the physical quantity derived by the deriving unit indicates a predetermined quality.

### TECHNICAL FIELD

The present invention relates to a technique of a station-side optical network unit, a communication system, and a control method.

### BACKGROUND ART

A PON (passive optical network) has been widely commercialized as an optical access system. The PON has a point-to-multipoint topology, and a plurality of subscriber-side optical network units (ONUs) communicate with one optical network unit (OLT) via an optical splitter (see, for example, Non Patent Literature 1).

Meanwhile, in the next-generation optical access technology, application of multiplexing systems using a digital signal processing technology, such as OFDM (orthogonal frequency division multiplexing) or SCM (subcarrier multiplexing), to the PON has attracted attention. The multiplexing systems are used together with high-order modulation techniques and can be implemented by an inexpensive transceiver circuit having a narrow frequency band because of high bandwidth utilization efficiency. Therefore, further economic efficiency of the PON can be expected. Further, a dedicated subcarrier can be allocated to each user from a plurality of subcarriers, which makes it possible to flexibly support a new service (see, for example, Non Patent Literature 2).

### CITATION LIST

### Non Patent Literature

Non Patent Literature 1: Gijutsu kiso koza “GE-PON gijutsu”, Dai 1-kai (in Japanese) (Technical Basic Course “GE-PON Technology”, Part 1), NTT Technical Review, 2005. 8

Non Patent Literature 2: D. Qian, et al., “10.8-Gb/s OFDMA-PON Transmission Performance Study”, Proc. Conf. Optical Fiber Communication, NME6, March 2009.

### SUMMARY OF INVENTION

### Technical Problem

In the point-to-multipoint topology of the PON, optical loss between the OLT and each ONU is different, and the OLT generates a downlink signal by using one light source. Therefore, an SNR (signal-to-noise ratio) of a signal received by each ONU is different for each ONU, and thus a transmission distance and the number of branches of a PON system are determined based on an ONU having the smallest SNR. Powers of signals are wasted in ONUs other than the ONU having the smallest SNR, which causes limitation of the transmission distance and a power budget of the PON system.

In view of the above circumstances, an object of the present invention is to provide a technique capable of appropriately controlling power of a signal.

### Solution to Problem

An aspect of the present invention is a station-side optical network unit to be connected to a subscriber-side optical network unit, the station-side optical network unit including: an acquisition unit that acquires, from the subscriber-side optical network unit, a signal-to-noise ratio of a received signal transmitted from the station-side optical network unit and received by the subscriber-side optical network unit; a deriving unit that derives a physical quantity indicating a quality of the received signal from the signal-to-noise ratio acquired by the acquisition unit; and a setting unit that sets a power of a signal transmitted by the station-side optical network unit to a minimum power among powers at which the physical quantity derived by the deriving unit indicates a predetermined quality.

An aspect of the present invention is a communication system including a subscriber-side optical network unit and a station-side optical network unit to be connected to the subscriber-side optical network unit, in which: the station-side optical network unit includes an acquisition unit that acquires, from the subscriber-side optical network unit, a signal-to-noise ratio of a received signal transmitted from the station-side optical network unit and received by the subscriber-side optical network unit, a deriving unit that derives a physical quantity indicating a quality of the received signal from the signal-to-noise ratio acquired by the acquisition unit, and a setting unit that sets a power of a signal transmitted by the station-side optical network unit to a minimum power among powers at which the physical quantity derived by the deriving unit indicates a predetermined quality; and the subscriber-side optical network unit includes a measurement unit that measures the signal-to-noise ratio of the received signal, and a transmission unit that transmits the signal-to-noise ratio measured by the measurement unit to the station-side optical network unit.

An aspect of the present invention is a control method of a station-side optical network unit to be connected to a subscriber-side optical network unit, the control method including: an acquisition step of acquiring, from the subscriber-side optical network unit, a signal-to-noise ratio of a received signal transmitted from the station-side optical network unit and received by the subscriber-side optical network unit; a deriving step of deriving a physical quantity indicating a quality of the received signal from the signal-to-noise ratio acquired in the acquisition step; and a setting step of setting a power of a signal transmitted by the station-side optical network unit to a minimum power among powers at which the physical quantity derived in the deriving step indicates a predetermined quality.

An aspect of the present invention is a control method of a communication system including a subscriber-side optical network unit and a station-side optical network unit to be connected to the subscriber-side optical network unit, in which: the station-side optical network unit acquires, from the subscriber-side optical network unit, a signal-to-noise ratio of a received signal transmitted from the station-side optical network unit and received by the subscriber-side optical network unit, derives a physical quantity indicating a quality of the received signal from the acquired signal-to-noise ratio, and sets a power of a signal transmitted by the station-side optical network unit to a minimum power among powers at which the derived physical quantity indicates a predetermined quality; and the subscriber-side optical network unit measures the signal-to-noise ratio of the received signal, and transmits the measured signal-to-noise ratio to the station-side optical network unit.

### Advantageous Effects of Invention

The present invention can appropriately control power of a signal.

### BRIEF DESCRIPTION OF DRAWINGS

FIG. 1 shows a schematic configuration of a communication system according to the present embodiment.

FIG. 2 is a block diagram showing a configuration of an OLT in a first configuration example.

FIG. 3 is a block diagram showing a configuration of an ONU in the first configuration example.

FIG. 4 is a flowchart showing a flow of processing of an OLT.

FIG. 5 is a block diagram showing a configuration of an OLT in a second configuration example.

FIG. 6 is a block diagram showing a configuration of an ONU in the second configuration example.

FIG. 7 is a block diagram showing a configuration of an OLT in a third configuration example.

FIG. 8 is a block diagram showing a configuration of an ONU in the third configuration example.

FIG. 9 is a block diagram showing a configuration of an OLT in a fourth configuration example.

FIG. 10 is a block diagram showing a configuration of an ONU in the fourth configuration example.

### DESCRIPTION OF EMBODIMENTS

Embodiments of the present invention will be described in detail with reference to the drawings.

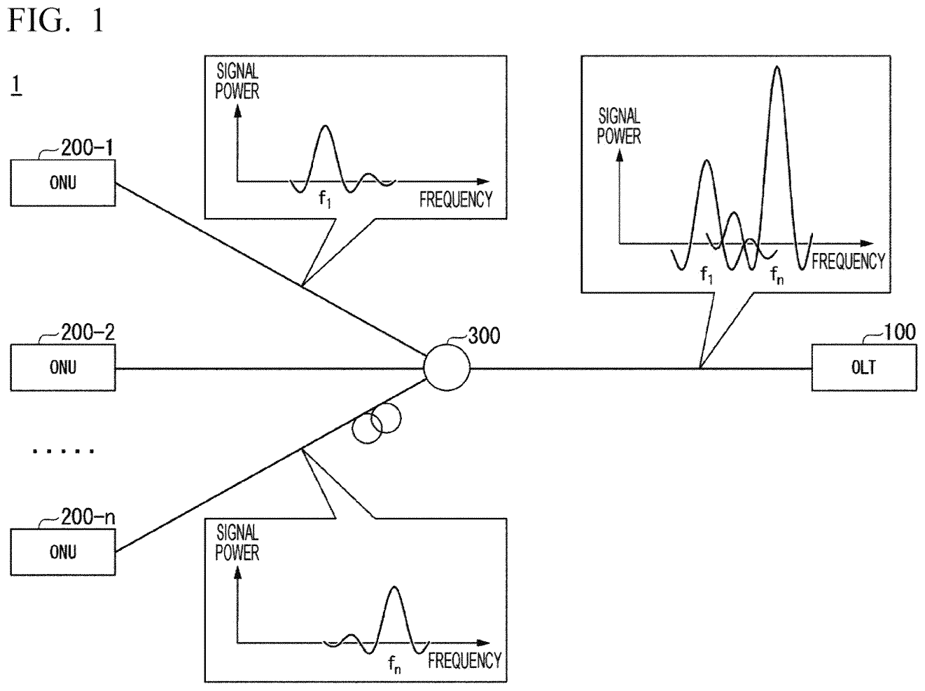

FIG. 1 shows a schematic configuration of a communication system 1 according to the present embodiment. The communication system 1 includes a station-side optical network unit (hereinafter, referred to as “OLT”) 100, subscriber-side optical network units (hereinafter, referred to as “ONUs”) 200-1, 200-2, . . . , and 200-n, and an optical splitter 300. In the following description, the ONUs 200-1, 200-2, . . . , and 200-n will be referred to as the ONUs 200 unless otherwise distinguished.

As shown in FIG. 1, the communication system 1 according to the present embodiment is a PON (passive optical network) system, and the ONUs 200 communicate with one OLT 100 via the optical splitter 300. The communication system 1 allocates a dedicated subcarrier (f1, . . . , and fn) to each ONU 200.

The OLT 100 in the present embodiment sets a power of a signal transmitted by the OLT 100 to a minimum power among powers indicating a predetermined quality. For example, as shown in FIG. 1, optical powers of signals received by the ONU 200-1 and the ONU 200-n are substantially the same even if optical losses caused by optical fibers or the like are different, and the optical powers are powers indicating the predetermined quality. Meanwhile, regarding signal powers from the OLT 100 to the optical splitter 300, the signal power at the frequency f1 is greatly different from the signal power at the frequency fn. As described above, different powers are set to each ONU 200 in order to set the power of the signal transmitted by the OLT 100 to the power indicating the predetermined quality.

In the following description, a frequency allocated to an ONU 200-k (k=1 to n) is denoted by fk.

### First Configuration Example

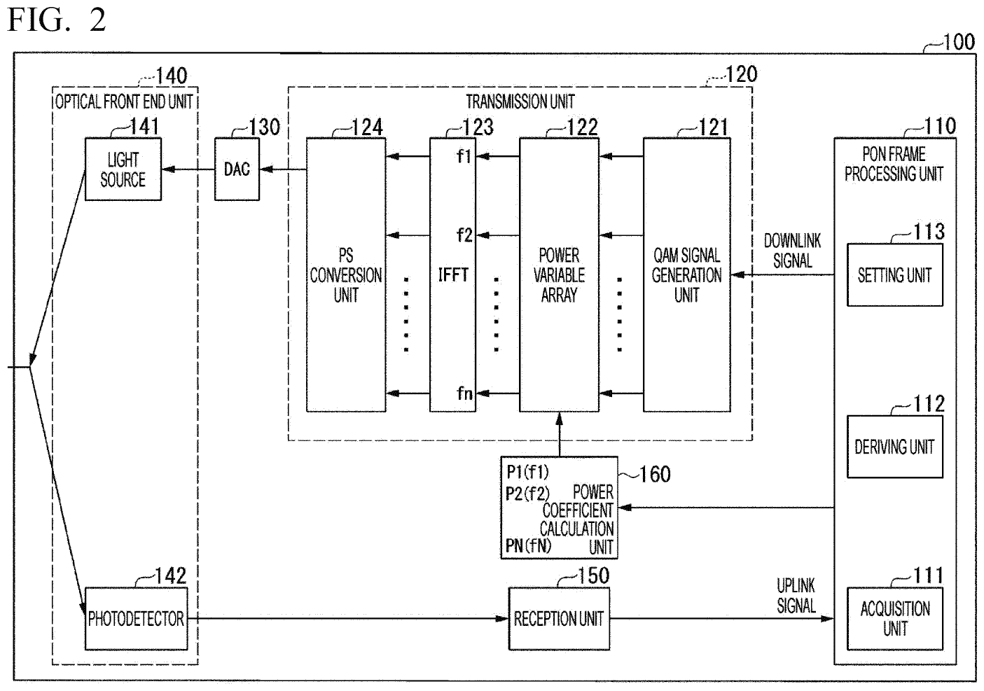

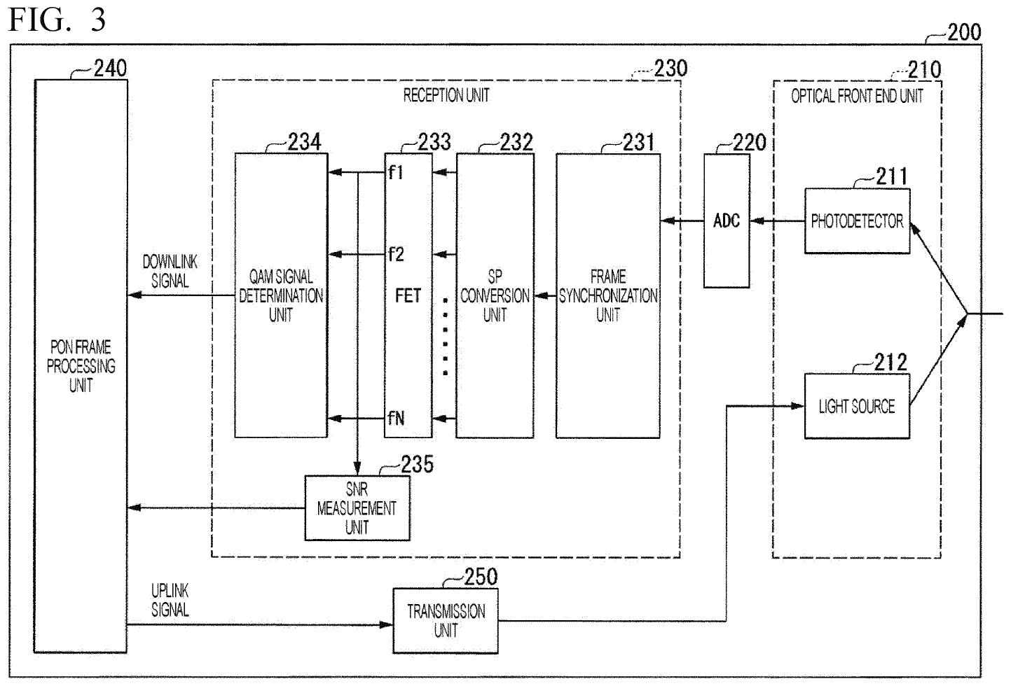

FIG. 2 is a block diagram showing a configuration of the OLT 100 in a first configuration example of the embodiment. The first configuration example shows the configuration of the OLT 100 in a case where the present embodiment is applied to an OFDM multiplexing system. FIG. 3 is a block diagram showing a configuration of the ONU 200 in the first configuration example.

As shown in FIG. 2, the OLT 100 includes a PON frame processing unit 110, a transmission unit 120, a DAC (DA converter) 130, an optical front end unit 140, a reception unit 150, and a power coefficient calculation unit 160.

The PON frame processing unit 110 performs processing related to a frame including a signal to be transmitted to the ONU 200 and outputs the processed frame to the transmission unit 120. The PON frame processing unit 110 includes an acquisition unit 111, a deriving unit 112, and a setting unit 113. The acquisition unit 111 acquires, from the ONU 200, a signal-to-noise ratio (hereinafter, also referred to as “SNR”) of a received signal transmitted from the OLT 100 and received by the ONU 200. The deriving unit 112 derives a physical quantity indicating the quality of the received signal from the acquired SNR. In the present embodiment, EVM (error vector magnitude) or BER (bit error rate) is used as the physical quantity, but the physical quantity is not limited thereto. The setting unit 113 sets a power of a signal transmitted by the OLT 100 to the minimum power among powers at which the physical quantity derived by the deriving unit 112 indicates the predetermined quality. As information for outputting a signal having the set power, a power coefficient corresponding to the power is held by the power coefficient calculation unit 160.

The transmission unit 120 includes a QAM (quadrature amplitude modulation) signal generation unit 121, a power variable array 122, IFFT (inverse fast Fourier transform) 123, and a PS conversion unit 124. In a case where the power of the signal transmitted by the OLT 100 is set to the minimum power among the powers at which the derived physical quantity indicates the predetermined quality, the QAM signal generation unit 121 generates a test pattern.

The QAM signal generation unit 121 generates a QAM signal corresponding to the frame output from the PON frame processing unit 110 for each ONU 200 and outputs the QAM signals to the power variable array 122.

The power variable array 122 acquires power coefficients set in the power coefficient calculation unit 160, converts the QAM signals into signals having powers corresponding to the acquired power coefficients, and outputs the signals to the IFFT 123. The power coefficient calculation unit 160 calculates and holds power coefficients P1(f1) to P1(fn) corresponding to the respective frequencies f1 to fn. The power coefficients P1(f1) to P1(fn) having initial values are set in the power coefficient calculation unit 160 before being set by the setting unit 113. The power coefficients having the initial values are coefficients for outputting a signal at a maximum power, for example.

The IFFT 123 performs inverse Fourier fast transform on each signal output from the power variable array 122 and outputs the signal to the PS conversion unit 124. The PS conversion unit 124 converts a parallel signal output from the IFFT 123 into a serial signal and outputs the serial signal to the DAC 130. The DAC 130 converts the digital serial signal into an analog signal and outputs the analog signal to the optical front end unit 140.

The optical front end unit 140 includes a light source 141 and a photodetector 142. The light source 141 is, for example, a laser diode and outputs a laser beam in response to the analog signal output from the DAC 130. The photodetector 142 is, for example, a photodiode, converts an optical signal transmitted from the ONU 200 into an electrical signal, and outputs the electrical signal to the reception unit 150. The reception unit 150 outputs the signal output from the optical front end unit 140 to the PON frame processing unit 110.

Next, the configuration of the ONU 200 in the first configuration example will be described with reference to FIG. 3. As shown in FIG. 3, the ONU 200 includes an optical front end unit 210, an ADC (AD converter) 220, a reception unit 230, a PON frame processing unit 240, and a transmission unit 250.

The optical front end unit 210 includes a photodetector 211 and a light source 212. The photodetector 211 is, for example, a photodiode, converts an optical signal transmitted from the OLT 100 into an electrical signal, and outputs the electrical signal to the ADC 220. The ADC 220 converts an analog signal output from the photodetector 211 into a digital signal and outputs the digital signal to the reception unit 230.

The reception unit 230 includes a frame synchronization unit 231, an SP conversion unit 232, FFT (fast Fourier transform) 233, a QAM signal determination unit 234, and an SNR measurement unit 235. The frame synchronization unit 231 detects the head of the frame from the signal output from the ADC 220, extracts the frame, and outputs the frame to the SP conversion unit 232. The SP conversion unit 232 converts a multiplexed serial signal output from the frame synchronization unit 231 into a parallel signal and outputs the parallel signal to the FFT 233. The FFT 233 performs fast Fourier transform on the input signal for each of the frequencies f1 to fn and outputs the signal to the QAM signal determination unit 234. The QAM signal determination unit 234 determines a corresponding symbol from the signal subjected to the fast Fourier transform and outputs the determination result to the PON frame processing unit 240.

The SNR measurement unit 235 measures the SNR on the basis of the output from the FFT 233 and outputs the measurement result to the PON frame processing unit 240. The PON frame processing unit 240 outputs the measured SNR to the transmission unit 250 as an uplink signal. The transmission unit 250 outputs the uplink signal to the light source 212. The light source 212 is, for example, a laser diode and outputs a laser beam in response to the signal output from the transmission unit 250.

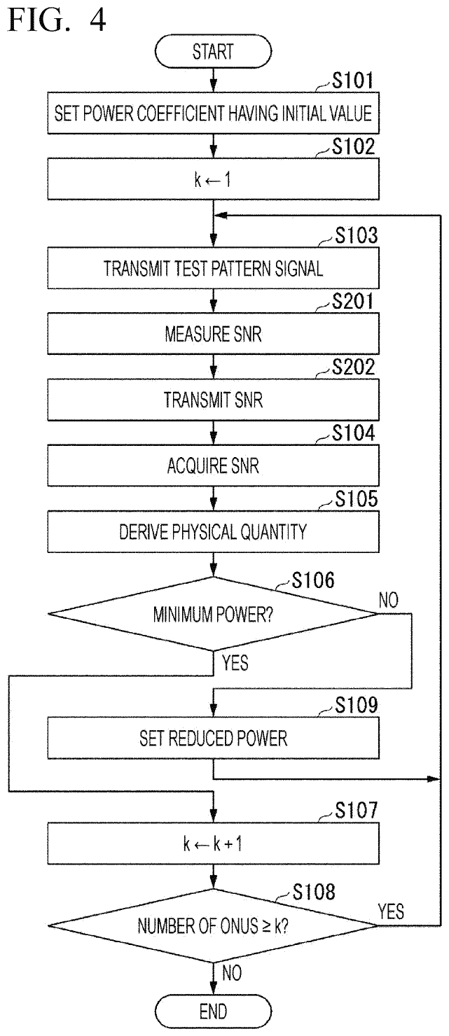

FIG. 4 is a flowchart showing a flow of processing of the OLT 100 and the ONU 200. The processing of the OLT 100 is indicated by step S1XX, and the processing of the ONU 200 is indicated by step S2XX. In FIG. 4, the setting unit 113 of the OLT 100 sets a power coefficient having an initial value in the power coefficient calculation unit 160 (step S101). Next, the setting unit 113 initializes a loop counter k to 1 (step S102).

The OLT 100 transmits a test pattern signal to the ONU 200 corresponding to the frequency fk (step S103). The SNR measurement unit 235 of the ONU 200 measures the SNR of the received signal (step S201). The SNR measurement unit 235 outputs the measured SNR to the PON frame processing unit 240, and the PON frame processing unit 240 outputs the measured SNR to the transmission unit 250 as an uplink signal. The transmission unit 250 transmits the SNR to the OLT 100 (step S202). The acquisition unit 111 acquires, from the ONU 200, the SNR of the received signal transmitted from the OLT 100 and received by the ONU 200 (step S104).

The deriving unit 112 derives a physical quantity indicating the quality of the received signal from the acquired SNR (step S105). The setting unit 113 determines whether or not the derived physical quantity is the minimum power among the powers indicating the predetermined quality (step S106). Here, when the physical quantity is denoted by BER, the predetermined quality is a quality at which the BER is 0.001 or less. The power coefficient set as the initial value is set to a value at which the BER is smaller than 0.001. Therefore, the power coefficient set as the initial value is likely to be more than necessary. Accordingly, in order to set the physical quantity derived by the deriving unit 112 to the minimum power among the powers indicating the predetermined quality, the setting unit 113 sets the power coefficient so as to reduce the power.

In step S106, whether or not the physical quantity is the minimum power is determined to be positive when, for example, |BER−0.001|<α (α is a positive number and is a value determined to be normally receivable by the ONU 200 through an experiment, for example) is satisfied.

When it is determined that the physical quantity is not the minimum power (step S106: NO), the setting unit 113 sets a power obtained by reducing the currently set power coefficient (step S109). Specifically, in order to set a power obtained by reducing the currently set power coefficient, the setting unit 113 causes the power coefficient calculation unit 160 to calculate and hold a power coefficient corresponding to the reduced power. The power coefficient calculation unit 160 reduces the power coefficient stepwise, for example, by each constant. Therefore, the power is reduced stepwise. In step S103 described above, the test pattern signal having the reduced power is transmitted.

When it is determined that the physical quantity is the minimum power (step S106: YES), the setting unit 113 increments the loop counter k (step S107). The setting unit 113 determines whether or not the loop counter k is smaller than the number n of ONUs 200 (step S108). When the loop counter k is smaller than the number n of ONUs 200 (step S108: YES), the setting unit 113 returns to step S103 to set a power of the ONU 200-k corresponding to fk. When the loop counter k is not smaller than the number n of ONUs 200 (step S108: NO), the setting unit 113 ends the processing because the power has been set for all the ONUs 200.

The flowchart in FIG. 4 may be performed every predetermined period of time or in a case where the topology is changed.

As described above, the setting unit 113 sets the power of the signal transmitted by the OLT 100 to the minimum power among the powers at which the physical quantity derived by the deriving unit 112 indicates the predetermined quality. This makes it possible to suppress waste of power while maintaining the predetermined quality for each ONU 200. Therefore, the power of the signal can be appropriately controlled.

### Second Configuration Example

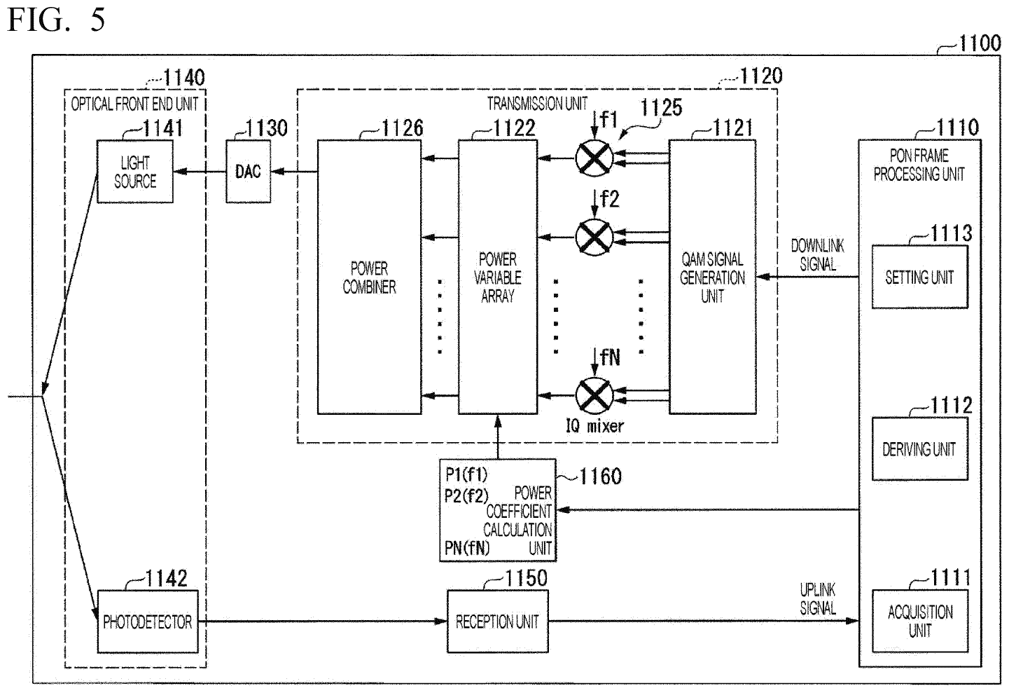

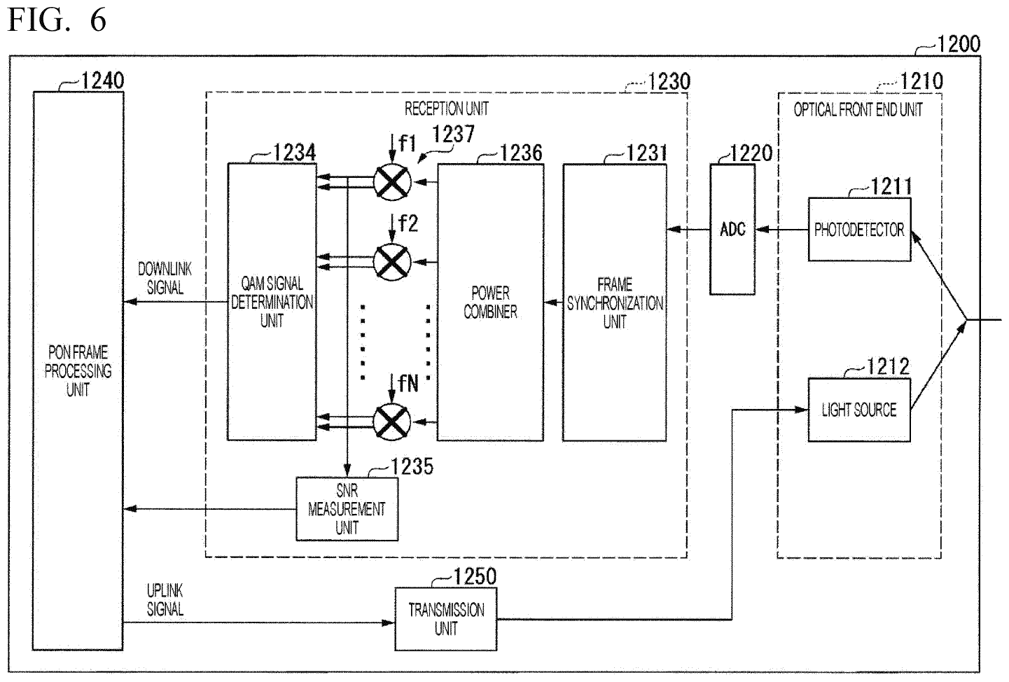

FIG. 5 is a block diagram showing a configuration of an OLT 1100 in a second configuration example of the embodiment. The second configuration example shows the configuration of the OLT 1100 in a case where the present embodiment is applied to an SCM multiplexing system. FIG. 6 is a block diagram showing a configuration of an ONU 1200 in the second configuration example.

As shown in FIG. 5, the OLT 1100 includes a PON frame processing unit 1110, a transmission unit 1120, a DAC (DA converter) 1130, an optical front end unit 1140, a reception unit 1150, and a power coefficient calculation unit 1160.

The PON frame processing unit 1110 performs processing related to a frame including a signal to be transmitted to the ONU 1200 and outputs the processed frame to the transmission unit 1120. The PON frame processing unit 1110 includes an acquisition unit 1111, a deriving unit 1112, and a setting unit 1113. The acquisition unit 1111 acquires, from the ONU 1200, the SNR of a received signal transmitted from the OLT 1100 and received by the ONU 1200. The deriving unit 1112 derives a physical quantity indicating the quality of the received signal from the acquired SNR. In the present embodiment, the EVM or BER is used as the physical quantity, but the physical quantity is not limited thereto. The setting unit 1113 sets a power of a signal transmitted by the OLT 1100 to the minimum power among powers at which the physical quantity derived by the deriving unit 1112 indicates the predetermined quality. As information for outputting a signal having the set power, a power coefficient corresponding to the power is held by the power coefficient calculation unit 1160.

The transmission unit 1120 includes a QAM signal generation unit 1121, IQ mixers 1125, a power variable array 1122, and a power combiner 1126. In a case where the power of the signal transmitted by the OLT 1100 is set to the minimum power among the powers at which the derived physical quantity indicates the predetermined quality, the QAM signal generation unit 1121 generates a test pattern.

The QAM signal generation unit 1121 generates a QAM signal corresponding to the frame output from the PON frame processing unit 1110 for each ONU 1200 and outputs the QAM signal to each IQ mixer 1125. The IQ mixer 1125 is provided for each of the frequencies f1 to fN. The IQ mixer 1125 modulates the QAM signal and outputs the modulated QAM signal to the power variable array 1122.

The power variable array 1122 acquires power coefficients set in the power coefficient calculation unit 1160, converts the signals output from the IQ mixers 1125 into signals having powers corresponding to the acquired power coefficients, and outputs the signals to the power combiner 1126. The power coefficient calculation unit 1160 calculates and holds the power coefficients P1(f1) to P1(fn) corresponding to the respective frequencies f1 to fn. The power coefficients P1(f1) to P1(fn) having initial values are set in the power coefficient calculation unit 1160 before being set by the setting unit 1113. The power coefficients having the initial values are coefficients for outputting a signal at a maximum power, for example.

The power combiner 1126 combines the signals output from the power variable array 1122 and outputs the combined signal to the DAC 1130. The DAC 1130 converts the signal output from the power combiner 1126 into an analog signal and outputs the analog signal to the optical front end unit 1140.

The optical front end unit 1140 includes a light source 1141 and a photodetector 1142. The light source 1141 is, for example, a laser diode and outputs a laser beam in response to the analog signal output from the DAC 1130. The photodetector 1142 is, for example, a photodiode, converts an optical signal transmitted from the ONU 1200 into an electrical signal, and outputs the electrical signal to the reception unit 1150. The reception unit 1150 outputs the signal output from the optical front end unit 1140 to the PON frame processing unit 1110.

Next, the configuration of the ONU 1200 in the second configuration example will be described with reference to FIG. 6. As shown in FIG. 6, the ONU 1200 includes an optical front end unit 1210, an ADC (AD converter) 1220, a reception unit 1230, a PON frame processing unit 1240, and a transmission unit 1250.

The optical front end unit 1210 includes a photodetector 1211 and a light source 1212. The photodetector 1211 is, for example, a photodiode, converts an optical signal transmitted from the OLT 1100 into an electrical signal, and outputs the electrical signal to the ADC 1220. The ADC 1220 converts an analog signal output from the photodetector 1211 into a digital signal and outputs the digital signal to the reception unit 1230.

The reception unit 1230 includes a frame synchronization unit 1231, a power combiner 1236, IQ mixers 1237, a QAM signal determination unit 1234, and an SNR measurement unit 1235. The frame synchronization unit 1231 detects the head of the frame from the signal output from the ADC 1220, extracts the frame, and outputs the frame to the power combiner 1236. The power combiner 1236 demultiplexes the signal output from the frame synchronization unit 1231 and outputs the demultiplexed signals to the IQ mixers 1237. The IQ mixer 1237 is provided for each of the frequencies f1 to fN. The IQ mixer 1237 demodulates the input signal and outputs the demodulated signal to the QAM signal determination unit 1234. The QAM signal determination unit 1234 determines a corresponding symbol on the basis of the signal demodulated by the IQ mixer 1237 and outputs the determination result to the PON frame processing unit 1240.

The SNR measurement unit 1235 measures the SNR on the basis of the output from the IQ mixer 1237 and outputs the measurement result to the PON frame processing unit 1240. The PON frame processing unit 1240 outputs the measured SNR to the transmission unit 1250 as an uplink signal. The transmission unit 1250 outputs the uplink signal to the light source 1212. The light source 1212 is, for example, a laser diode and outputs a laser beam in response to the signal output from the transmission unit 1250.

Also in the second configuration example, it is possible to suppress waste of power while maintaining the predetermined quality for each ONU by processing similar to the processing in FIG. 4. Therefore, the power of the signal can be appropriately controlled.

A flow of the processing in the second configuration example will be described by diverting the flowchart of FIG. 4. In FIG. 4, the setting unit 1113 of the OLT 1100 sets a power coefficient having an initial value in the power coefficient calculation unit 1160 (step S101). Next, the setting unit 1113 initializes the loop counter k to 1 (step S102).

The OLT 1100 transmits a test pattern signal to the ONU 1200 corresponding to the frequency fk (step S103). The SNR measurement unit 1235 of the ONU 1200 measures the SNR of the received signal (step S201). The SNR measurement unit 1235 outputs the measured SNR to the PON frame processing unit 1240, and the PON frame processing unit 1240 outputs the measured SNR to the transmission unit 1250 as an uplink signal. The transmission unit 1250 transmits the SNR to the OLT 1100 (step S202). The acquisition unit 1111 acquires, from the ONU 1200, the SNR of the received signal transmitted from the OLT 1100 and received by the ONU 1200 (step S104).

The deriving unit 1112 derives a physical quantity indicating the quality of the received signal from the acquired SNR (step S105). The setting unit 1113 determines whether or not the derived physical quantity is the minimum power among the powers indicating the predetermined quality (step S106). Here, when the physical quantity is denoted by BER, the predetermined quality is a quality at which the BER is 0.001 or less. The power coefficient set as the initial value is set to a value at which the BER is smaller than 0.001. Therefore, the power coefficient set as the initial value is likely to be more than necessary. Accordingly, in order to set the physical quantity derived by the deriving unit 1112 to the minimum power among the powers indicating the predetermined quality, the setting unit 1113 sets the power coefficient so as to reduce the power.

In step S106, whether or not the physical quantity is the minimum power is determined to be positive when, for example, |BER−0.001|<α (α is a positive number and is a value determined to be normally receivable by the ONU 1200 through an experiment, for example) is satisfied.

When it is determined that the physical quantity is not the minimum power (step S106: NO), the setting unit 1113 sets a power obtained by reducing the currently set power coefficient (step S109). Specifically, in order to set a power obtained by reducing the currently set power coefficient, the setting unit 1113 causes the power coefficient calculation unit 1160 to calculate and hold a power coefficient corresponding to the reduced power. The power coefficient calculation unit 1160 reduces the power coefficient stepwise, for example, by each constant. Therefore, the power is reduced stepwise. In step S103 described above, the test pattern signal having the reduced power is transmitted.

When it is determined that the physical quantity is the minimum power (step S106: YES), the setting unit 1113 increments the loop counter k (step S107). The setting unit 1113 determines whether or not the loop counter k is equal to or smaller than the number n of ONUs 1200 (step S108). When the loop counter k is equal to or smaller than the number n of ONUs 1200 (step S108: YES), the setting unit 1113 returns to step S103 to set a power of an ONU 1200-k corresponding to fk. When the loop counter k is larger than the number n of ONUs 1200 (step S108: NO), the setting unit 1113 ends the processing because the power has been set for all the ONUs 1200.

In the second configuration example, the flowchart in FIG. 4 may be performed every predetermined period of time or in a case where the topology is changed.

As described above, the setting unit 1113 sets the power of the signal transmitted by the OLT 1100 to the minimum power among the powers at which the physical quantity derived by the deriving unit 1112 indicates the predetermined quality. This makes it possible to suppress waste of power while maintaining the predetermined quality for each ONU 1200. Therefore, the power of the signal can be appropriately controlled.

### Third Configuration Example

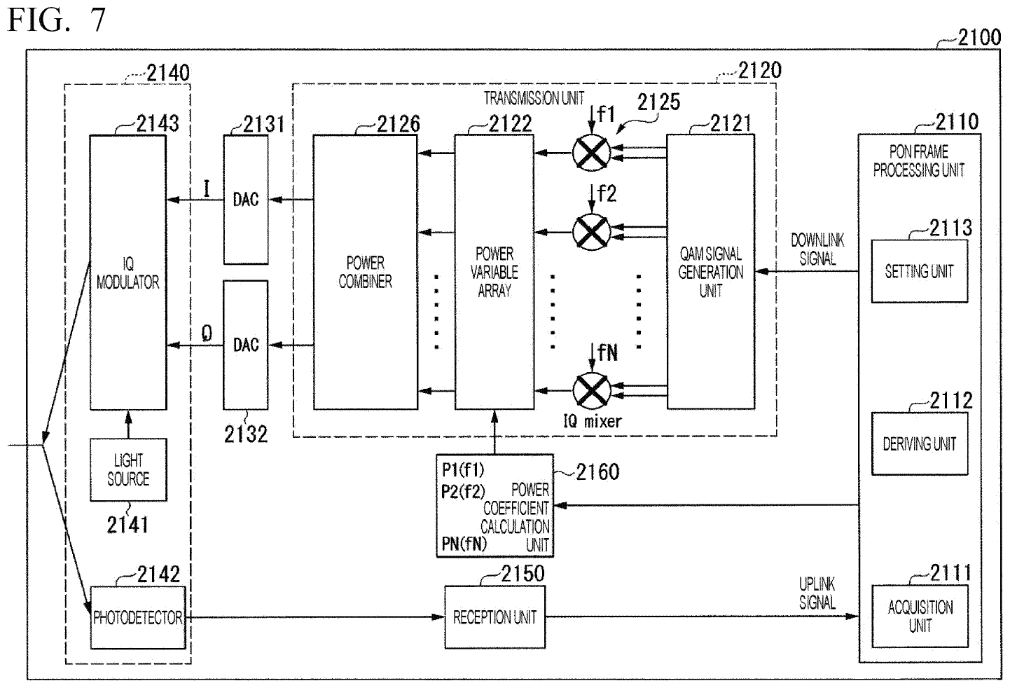

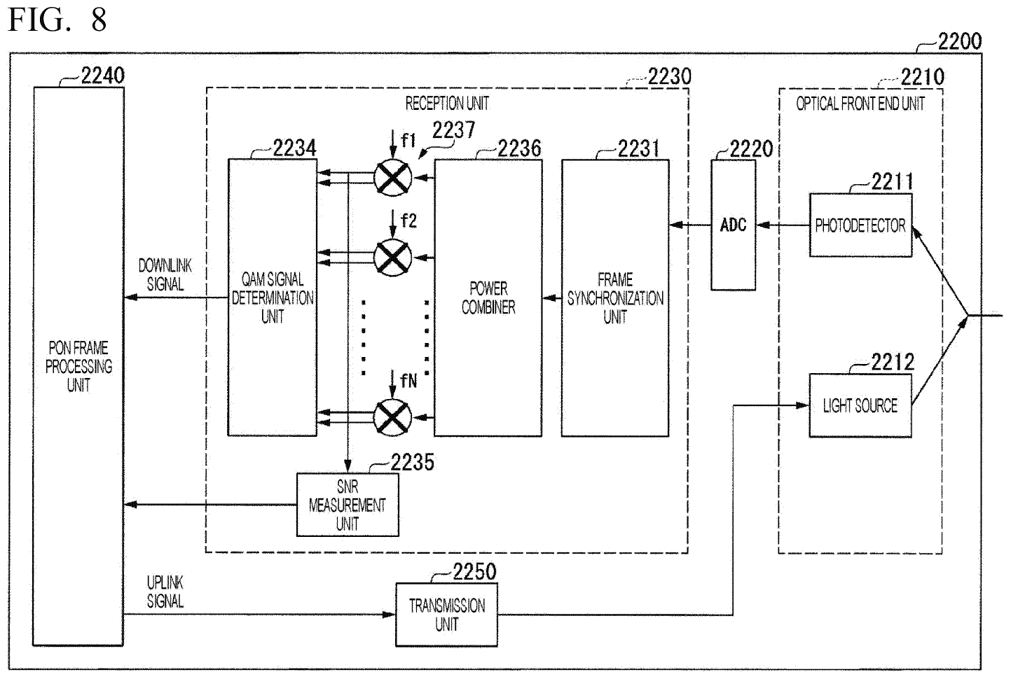

FIG. 7 is a block diagram showing a configuration of an OLT 2100 in a third configuration example of the embodiment. The third configuration example shows the configuration of the OLT 2100 in a case where the present embodiment is applied to an SSB (single sideband)-SCM multiplexing system. FIG. 8 is a block diagram showing a configuration of an ONU 2200 in the third configuration example.

As shown in FIG. 7, the OLT 2100 includes a PON frame processing unit 2110, a transmission unit 2120, DACs (DA converters) 2131 and 2132, an optical front end unit 2140, a reception unit 2150, and a power coefficient calculation unit 2160. The PON frame processing unit 2110 performs processing related to a frame including a signal to be transmitted to the ONU 2200 and outputs the processed frame to the transmission unit 2120. The PON frame processing unit 2110 includes an acquisition unit 2111, a deriving unit 2112, and a setting unit 2113. The acquisition unit 2111 acquires, from the ONU 2200, the SNR of a received signal transmitted from the OLT 2100 and received by the ONU 2200. The deriving unit 2112 derives a physical quantity indicating the quality of the received signal from the acquired SNR. In the present embodiment, the EVM or BER is used as the physical quantity, but the physical quantity is not limited thereto. The setting unit 2113 sets a power of a signal transmitted by the OLT 2100 to the minimum power among powers at which the physical quantity derived by the deriving unit 2112 indicates the predetermined quality. As information for outputting a signal having the set power, a power coefficient corresponding to the power is held by the power coefficient calculation unit 2160.

The transmission unit 2120 includes a QAM signal generation unit 2121, IQ mixers 2125, a power variable array 2122, and a power combiner 2126. In a case where the power of the signal transmitted by the OLT 2100 is set to the minimum power among the powers at which the derived physical quantity indicates the predetermined quality, the QAM signal generation unit 2121 generates a test pattern.

The QAM signal generation unit 2121 generates a QAM signal corresponding to the frame output from the PON frame processing unit 2110 for each ONU 2200 and outputs the QAM signal to each IQ mixer 2125. The IQ mixer 2125 is provided for each of the frequencies f1 to fN. The IQ mixer 2125 modulates the QAM signal and outputs the modulated QAM signal to the power variable array 2122.

The power variable array 2122 acquires power coefficients set in the power coefficient calculation unit 2160, converts the signals output from the IQ mixers 2125 into signals having powers corresponding to the acquired power coefficients, and outputs the signals to the power combiner 2126. The power coefficient calculation unit 2160 calculates and holds the power coefficients P1(f1) to P1(fn) corresponding to the respective frequencies f1 to fn. The power coefficients P1(f1) to P1(fn) having initial values are set in the power coefficient calculation unit 2160 before being set by the setting unit 2113. The power coefficients having the initial values are coefficients for outputting a signal at a maximum power, for example.

The power combiner 2126 combines the signals output from the power variable array 2122, outputs an in-phase component signal to the DAC 2131, and outputs a quadrature component signal to the DAC 2132. The DACs 2131 and 2132 convert the signals output from the power combiner 2126 into analog signals and output the analog signals to the optical front end unit 2140.

The optical front end unit 2140 includes a light source 2141, an IQ modulator 2143, and a photodetector 2142. The light source 2141 is, for example, a laser diode. The IQ modulator 2143 receives the signals input from the DACs 2131 and 2132 and modulates and outputs laser beams output from the light source 2141 in response to the input signals. The photodetector 2142 is, for example, a photodiode, converts an optical signal transmitted from the ONU 2200 into an electrical signal, and outputs the electrical signal to the reception unit 2150. The reception unit 2150 outputs the signal output from the optical front end unit 2140 to the PON frame processing unit 2110.

Next, the configuration of the ONU 2200 in the third configuration example will be described with reference to FIG. 8. As shown in FIG. 8, the ONU 2200 includes an optical front end unit 2210, an ADC (AD converter) 2220, a reception unit 2230, a PON frame processing unit 2240, and a transmission unit 2250.

The optical front end unit 2210 includes a photodetector 2211 and a light source 2212. The photodetector 2211 is, for example, a photodiode, converts an optical signal transmitted from the OLT 2100 into an electrical signal, and outputs the electrical signal to the ADC 2220. The ADC 2220 converts an analog signal output from the photodetector 2211 into a digital signal and outputs the digital signal to the reception unit 2230.

The reception unit 2230 includes a frame synchronization unit 2231, a power combiner 2236, IQ mixers 2237, a QAM signal determination unit 2234, and an SNR measurement unit 2235. The frame synchronization unit 2231 detects the head of the frame from the signal output from the ADC 2220, extracts the frame, and outputs the frame to the power combiner 2236. The power combiner 2236 demultiplexes the signal output from the frame synchronization unit 2231 and outputs the demultiplexed signals to the IQ mixers 2237. The IQ mixer 2237 is provided for each of the frequencies f1 to fN. The IQ mixer 2237 demodulates the input signal and outputs the demodulated signal to the QAM signal determination unit 2234. The QAM signal determination unit 2234 determines a corresponding symbol on the basis of the signal demodulated by the IQ mixer 2237 and outputs the determination result to the PON frame processing unit 2240.

The SNR measurement unit 2235 measures the SNR on the basis of the output from the IQ mixer 2237 and outputs the measurement result to the PON frame processing unit 2240. The PON frame processing unit 2240 outputs the measured SNR to the transmission unit 2250 as an uplink signal. The transmission unit 2250 outputs the uplink signal to the light source 2212. The light source 2212 is, for example, a laser diode and outputs a laser beam in response to the signal output from the transmission unit 2250.

Also in the third configuration example, it is possible to suppress waste of power while maintaining the predetermined quality for each ONU by processing similar to the processing in FIG. 4. Therefore, the power of the signal can be appropriately controlled.

A flow of the processing in the third configuration example will be described by diverting the flowchart of FIG. 4. In FIG. 4, the setting unit 2113 of the OLT 2100 sets a power coefficient having an initial value in the power coefficient calculation unit 2160 (step S101). Next, the setting unit 2113 initializes the loop counter k to 1 (step S102).

The OLT 2100 transmits a test pattern signal to the ONU 2200 corresponding to the frequency fk (step S103). The SNR measurement unit 2235 of the ONU 2200 measures the SNR of the received signal (step S201). The SNR measurement unit 2235 outputs the measured SNR to the PON frame processing unit 2240, and the PON frame processing unit 2240 outputs the measured SNR to the transmission unit 2250 as an uplink signal. The transmission unit 2250 transmits the SNR to the OLT 2100 (step S202). The acquisition unit 2111 acquires, from the ONU 2200, the SNR of the received signal transmitted from the OLT 2100 and received by the ONU 2200 (step S104).

The deriving unit 2112 derives a physical quantity indicating the quality of the received signal from the acquired SNR (step S105). The setting unit 2113 determines whether or not the derived physical quantity is the minimum power among the powers indicating the predetermined quality (step S106). Here, when the physical quantity is denoted by BER, the predetermined quality is a quality at which the BER is 0.001 or less. The power coefficient set as the initial value is set to a value at which the BER is smaller than 0.001. Therefore, the power coefficient set as the initial value is likely to be more than necessary. Accordingly, in order to set the physical quantity derived by the deriving unit 2112 to the minimum power among the powers indicating the predetermined quality, the setting unit 2113 sets the power coefficient so as to reduce the power.

In step S106, whether or not the physical quantity is the minimum power is determined to be positive when, for example, |BER−0.001|<α (α is a positive number and is a value determined to be normally receivable by the ONU 2200 through an experiment, for example) is satisfied.

When it is determined that the physical quantity is not the minimum power (step S106: NO), the setting unit 2113 sets a power obtained by reducing the currently set power coefficient (step S109). Specifically, in order to set a power obtained by reducing the currently set power coefficient, the setting unit 2113 causes the power coefficient calculation unit 2160 to calculate and hold a power coefficient corresponding to the reduced power. The power coefficient calculation unit 2160 reduces the power coefficient stepwise, for example, by each constant. Therefore, the power is reduced stepwise. In step S103 described above, the test pattern signal having the reduced power is transmitted.

When it is determined that the physical quantity is the minimum power (step S106: YES), the setting unit 2113 increments the loop counter k (step S107). The setting unit 2113 determines whether or not the loop counter k is smaller than the number n of ONUs 2200 (step S108). When the loop counter k is smaller than the number n of ONUs 2200 (step S108: YES), the setting unit 2113 returns to step S103 to set a power of an ONU 2200-k corresponding to fk. When the loop counter k is not smaller than the number n of ONUs 2200 (step S108: NO), the setting unit 2113 ends the processing because the power has been set for all the ONUs 2200.

In the third configuration example, the flowchart in FIG. 4 may be performed every predetermined period of time or in a case where the topology is changed.

As described above, the setting unit 2113 sets the power of the signal transmitted by the OLT 2100 to the minimum power among the powers at which the physical quantity derived by the deriving unit 2112 indicates the predetermined quality. This makes it possible to suppress waste of power while maintaining the predetermined quality for each ONU 2200. Therefore, the power of the signal can be appropriately controlled.

### Fourth Configuration Example

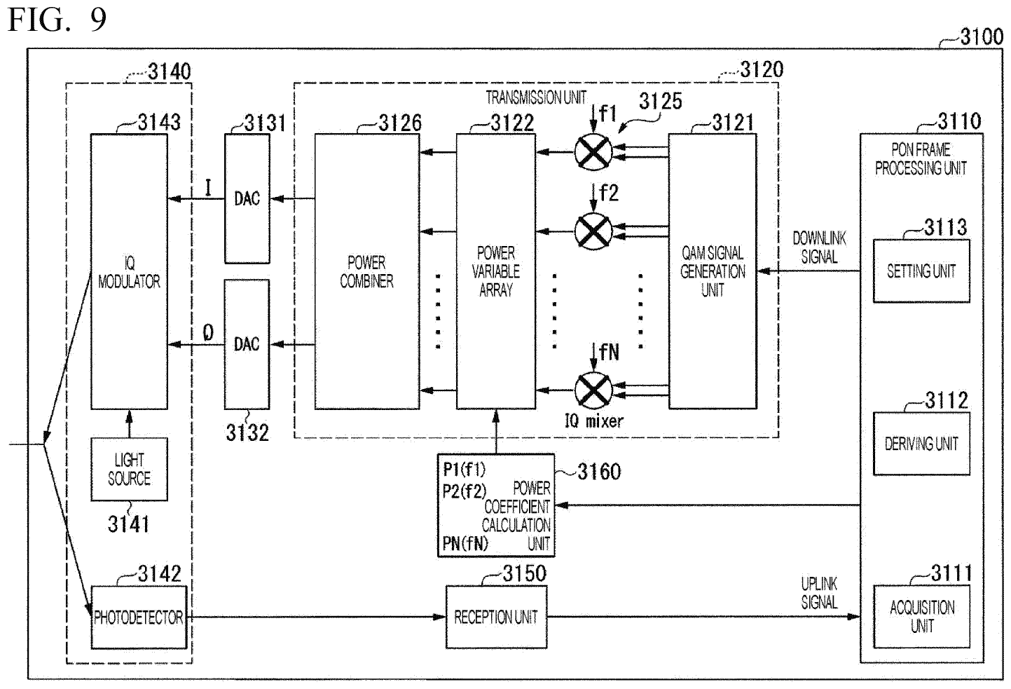

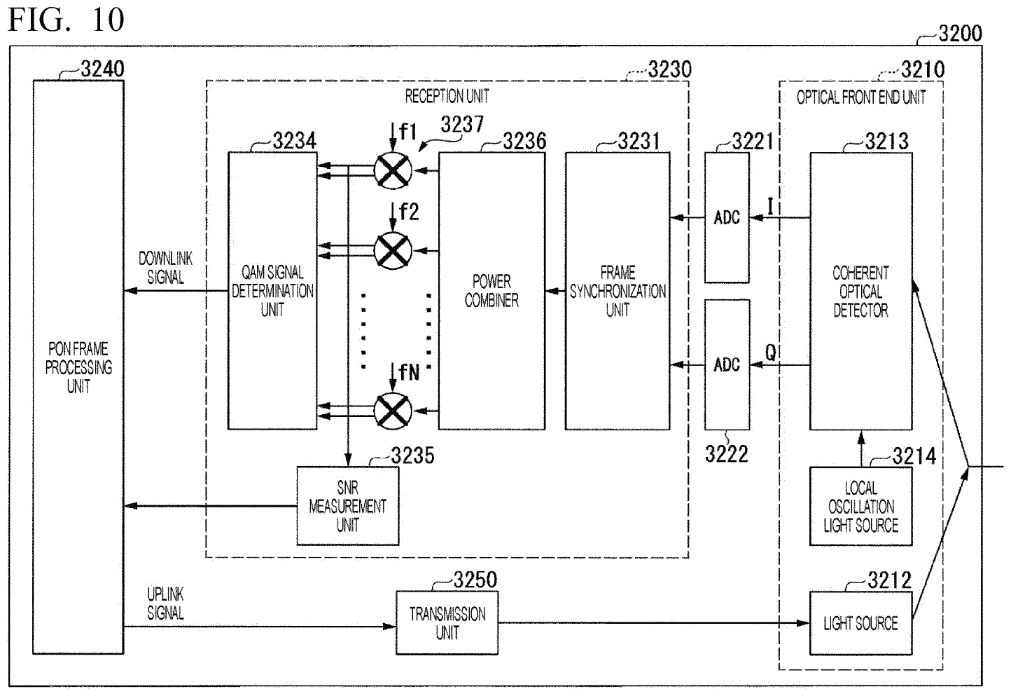

FIG. 9 is a block diagram showing a configuration of an OLT 3100 in a fourth configuration example of the embodiment. The fourth configuration example shows the configuration of the OLT 3100 in a case where the present embodiment is applied to the SSB-SCM multiplexing system. FIG. 10 is a block diagram showing a configuration of an ONU 3200 including a coherent optical detector in the fourth configuration example.

As shown in FIG. 9, the OLT 3100 includes a PON frame processing unit 3110, a transmission unit 3120, DACs (DA converters) 3131 and 3132, an optical front end unit 3140, a reception unit 3150, and a power coefficient calculation unit 3160.

The PON frame processing unit 3110 performs processing related to a frame including a signal to be transmitted to the ONU 3200 and outputs the processed frame to the transmission unit 3120. The PON frame processing unit 3110 includes an acquisition unit 3111, a deriving unit 3112, and a setting unit 3113. The acquisition unit 3111 acquires, from the ONU 3200, the SNR of a received signal transmitted from the OLT 3100 and received by the ONU 3200. The deriving unit 3112 derives a physical quantity indicating the quality of the received signal from the acquired SNR. In the present embodiment, the EVM or BER is used as the physical quantity, but the physical quantity is not limited thereto. The setting unit 3113 sets a power of a signal transmitted by the OLT 3100 to the minimum power among powers at which the physical quantity derived by the deriving unit 3112 indicates the predetermined quality. As information for outputting a signal having the set power, a power coefficient corresponding to the power is held by the power coefficient calculation unit 3160.

The transmission unit 3120 includes a QAM signal generation unit 3121, IQ mixers 3125, a power variable array 3122, and a power combiner 3126. In a case where the power of the signal transmitted by the OLT 3100 is set to the minimum power among the powers at which the derived physical quantity indicates the predetermined quality, the QAM signal generation unit 3121 generates a test pattern.

The QAM signal generation unit 3121 generates a QAM signal corresponding to the frame output from the PON frame processing unit 3110 for each ONU 3200 and outputs the QAM signal to each IQ mixer 3125. The IQ mixer 3125 is provided for each of the frequencies f1 to fN. The IQ mixer 3125 modulates the QAM signal and outputs the modulated QAM signal to the power variable array 3122.

The power variable array 3122 acquires power coefficients set in the power coefficient calculation unit 3160, converts the signals output from the IQ mixers 3125 into signals having powers corresponding to the acquired power coefficients, and outputs the signals to the power combiner 3126. The power coefficient calculation unit 3160 calculates and holds the power coefficients P1(f1) to P1(fn) corresponding to the respective frequencies f1 to fn. The power coefficients P1(f1) to P1(fn) having initial values are set in the power coefficient calculation unit 3160 before being set by the setting unit 3113. The power coefficients having the initial values are coefficients for outputting a signal at a maximum power, for example.

The power combiner 3126 combines the signals output from the power variable array 3122, outputs an in-phase component signal to the DAC 3131, and outputs a quadrature component signal to the DAC 3132. The DACs 3131 and 3132 convert the signals output from the power combiner 3126 into analog signals and output the analog signals to the optical front end unit 3140.

The optical front end unit 3140 includes a light source 3141, an IQ modulator 3143, and a photodetector 3142. The light source 3141 is, for example, a laser diode. The IQ modulator 3143 receives the signals input from the DACs 3131 and 3132 and modulates and outputs laser beams output from the light source 3141 in response to the input signals. The photodetector 3142 is, for example, a photodiode, converts an optical signal transmitted from the ONU 3200 into an electrical signal, and outputs the electrical signal to the reception unit 3150. The reception unit 3150 outputs the signal output from the optical front end unit 3140 to the PON frame processing unit 3110.

Next, the configuration of the ONU 3200 in the fourth configuration example will be described with reference to FIG. 10. As shown in FIG. 10, the ONU 3200 includes an optical front end unit 3210, ADCs (AD converters) 3221 and 3222, a reception unit 3230, a PON frame processing unit 3240, and a transmission unit 3250.

The optical front end unit 3210 includes a coherent optical detector 3213, a local oscillation light source 3214, and a light source 3212. The coherent optical detector 3213 detects an in-phase component signal and a quadrature component signal by causing a laser beam from the local oscillation light source 3214 to interfere with the received optical signal. The detected in-phase component signal is output to the ADC 3221. The detected quadrature component signal is output to the ADC 3222.

The ADC 3221 converts the in-phase component signal output from the coherent optical detector 3213 into a digital signal and outputs the digital signal to the reception unit 3230. The ADC 3222 converts the quadrature component signal output from the coherent optical detector 3213 into a digital signal and outputs the digital signal to the reception unit 3230.

The reception unit 3230 includes a frame synchronization unit 3231, a power combiner 3236, IQ mixers 3237, a QAM signal determination unit 3234, and an SNR measurement unit 3235. The frame synchronization unit 3231 detects the head of the frames from the signals output from the ADCs 3221 and 3222, extracts the frames, and outputs the frames to the power combiner 3236. The power combiner 3236 demultiplexes the signal output from the frame synchronization unit 3231 and outputs the demultiplexed signals to the IQ mixers 3237. The IQ mixer 3237 is provided for each of the frequencies f1 to fN. The IQ mixer 3237 demodulates the input signal and outputs the demodulated signal to the QAM signal determination unit 3234. The QAM signal determination unit 3234 determines a corresponding symbol on the basis of the signal demodulated by the IQ mixer 3237 and outputs the determination result to the PON frame processing unit 3240.

The SNR measurement unit 3235 measures the SNR on the basis of the output from the IQ mixer 3237 and outputs the measurement result to the PON frame processing unit 3240. The PON frame processing unit 3240 outputs the measured SNR to the transmission unit 3250 as an uplink signal. The transmission unit 3250 outputs the uplink signal to the light source 3212. The light source 3212 is, for example, a laser diode and outputs a laser beam in response to the signal output from the transmission unit 3250.

Also in the fourth configuration example, it is possible to suppress waste of power while maintaining the predetermined quality for each ONU by processing similar to the processing in FIG. 4. Therefore, the power of the signal can be appropriately controlled.

A flow of the processing in the fourth configuration example will be described by diverting the flowchart of FIG. 4. In FIG. 4, the setting unit 3113 of the OLT 3100 sets a power coefficient having an initial value in the power coefficient calculation unit 3160 (step S101). Next, the setting unit 3113 initializes the loop counter k to 1 (step S102).

The OLT 3100 transmits a test pattern signal to the ONU 3200 corresponding to the frequency fk (step S103). The SNR measurement unit 3235 of the ONU 3200 measures the SNR of the received signal (step S201). The SNR measurement unit 3235 outputs the measured SNR to the PON frame processing unit 3240, and the PON frame processing unit 3240 outputs the measured SNR to the transmission unit 3250 as an uplink signal. The transmission unit 3250 transmits the SNR to the OLT 3100 (step S202). The acquisition unit 3111 acquires, from the ONU 3200, the SNR of the received signal transmitted from the OLT 3100 and received by the ONU 3200 (step S104).

The deriving unit 3112 derives a physical quantity indicating the quality of the received signal from the acquired SNR (step S105). The setting unit 3113 determines whether or not the derived physical quantity is the minimum power among the powers indicating the predetermined quality (step S106). Here, when the physical quantity is denoted by BER, the predetermined quality is a quality at which the BER is 0.001 or less. The power coefficient set as the initial value is set to a value at which the BER is smaller than 0.001. Therefore, the power coefficient set as the initial value is likely to be more than necessary. Accordingly, in order to set the physical quantity derived by the deriving unit 3112 to the minimum power among the powers indicating the predetermined quality, the setting unit 3113 sets the power coefficient so as to reduce the power.

In step S106, whether or not the physical quantity is the minimum power is determined to be positive when, for example, |BER−0.001|<α (α is a positive number and is a value determined to be normally receivable by the ONU 3200 through an experiment, for example) is satisfied.

When it is determined that the physical quantity is not the minimum power (step S106: NO), the setting unit 3113 sets a power obtained by reducing the currently set power coefficient (step S109). Specifically, in order to set a power obtained by reducing the currently set power coefficient, the setting unit 3113 causes the power coefficient calculation unit 3160 to calculate and hold a power coefficient corresponding to the reduced power. The power coefficient calculation unit 3160 reduces the power coefficient stepwise, for example, by each constant. Therefore, the power is reduced stepwise. In step S103 described above, the test pattern signal having the reduced power is transmitted.

When it is determined that the physical quantity is the minimum power (step S106: YES), the setting unit 3113 increments the loop counter k (step S107). The setting unit 3113 determines whether or not the loop counter k is equal to or smaller than the number n of ONUs 3200 (step S108). When the loop counter k is equal to or smaller than the number n of ONUs 3200 (step S108: YES), the setting unit 3113 returns to step S103 to set a power of an ONU 3200-k corresponding to fk. When the loop counter k is larger than the number n of ONUs 3200 (step S108: NO), the setting unit 3113 ends the processing because the power has been set for all the ONUs 3200.

In the fourth configuration example, the flowchart in FIG. 4 may be performed every predetermined period of time or in a case where the topology is changed.

As described above, the setting unit 3113 sets the power of the signal transmitted by the OLT 3100 to the minimum power among the powers at which the physical quantity derived by the deriving unit 3112 indicates the predetermined quality. This makes it possible to suppress waste of power while maintaining the predetermined quality for each ONU 3200. Therefore, the power of the signal can be appropriately controlled.

In the embodiment described above, the power coefficient is reduced stepwise by each constant, but each constant may be a minimum unit that can be reduced. In any case, the power of the signal transmitted by the OLT is set to the minimum power among the powers at which the physical quantity indicates the predetermined quality from among the powers reduced stepwise.

The PON frame processing units 110, 240, 1110, 1240, 2110, 2240, 3110, and 3240, the transmission units 120, 1120, 2120, and 3120, the reception units 230, 1230, 2230, and 3230, and the power coefficient calculation units 160, 1160, 2160, and 3160 may be configured by using a processor such as a central processing unit (CPU) and a memory. In this case, the PON frame processing units 110, 240, 1110, 1240, 2110, 2240, 3110, and 3240, the transmission units 120, 1120, 2120, and 3120, the reception units 230, 1230, 2230, and 3230, and the power coefficient calculation units 160, 1160, 2160, and 3160 function as the PON frame processing units 110, 240, 1110, 1240, 2110, 2240, 3110, and 3240, the transmission units 120, 1120, 2120, and 3120, the reception units 230, 1230, 2230, and 3230, and the power coefficient calculation units 160, 1160, 2160, and 3160 by the processor executing a program. All or some of the functions of the PON frame processing units 110, 240, 1110, 1240, 2110, 2240, 3110, and 3240, the transmission units 120, 1120, 2120, and 3120, the reception units 230, 1230, 2230, and 3230, and the power coefficient calculation units 160, 1160, 2160, and 3160 may be implemented by using hardware such as an application specific integrated circuit (ASIC), a programmable logic device (PLD), or a field programmable gate array (FPGA). The above program may be recorded in a computer-readable recording medium. The computer-readable recording medium is, for example, a portable medium such as a flexible disk, a magneto-optical disc, a ROM, a CD-ROM, or a semiconductor storage device (e.g., a solid state drive (SSD)) or a storage device such as a hard disk or a semiconductor storage device built in a computer system. The program may be transmitted via a telecommunication line.

Although the embodiments of the present invention have been described in detail with reference to the drawings, specific configurations are not limited to the embodiments, and include design and the like within the scope of the present invention without departing from the gist of the present invention.

### Industrial Applicability

The present invention is applicable to a communication system that performs communication through an optical fiber transmission line.

### REFERENCE SIGNS LIST

1 . . . Communication system
100, 1100, 2100, 3100 . . . OLT
200, 1200, 2200, 3200 . . . ONU
111, 1111, 2111, 3111 . . . Acquisition unit
112, 1112, 2112, 3112 . . . Deriving unit
113, 1113, 2113, 3113 . . . Setting unit

1. A station-side optical network unit to be connected to a subscriber-side optical network unit, the station-side optical network unit comprising:
a processor; and
a storage medium having computer program instructions stored thereon, when executed by the processor, perform to:
acquire, from the subscriber-side optical network unit, a signal-to-noise ratio of a received signal transmitted from the station-side optical network unit and received by the subscriber-side optical network unit;
derive a physical quantity indicating a quality of the received signal from the signal-to-noise ratio acquired; and
set a power of a signal transmitted by the station-side optical network unit to a minimum power among powers at which the physical quantity derived indicates a predetermined quality.

2. The station-side optical network unit according to claim 1, wherein in a case where a plurality of the subscriber-side optical network units is connected, the processor sets the power of the signal transmitted by the subscriber-side optical network unit for each of the plurality of subscriber-side optical network units.

3. The station-side optical network unit according to claim 1, wherein the processor sets the power of the signal transmitted by the station-side optical network unit to the minimum power among the powers at which the physical quantity derived indicates the predetermined quality by reducing stepwise a power determined as an initial value.

4. A communication system comprising a subscriber-side optical network unit and a station-side optical network unit to be connected to the subscriber-side optical network unit, wherein
the station-side optical network unit comprises
a first processor; and
a first storage medium having computer program instructions stored thereon, when executed by the first processor, perform to:
acquire, from the subscriber-side optical network unit, a signal-to-noise ratio of a received signal transmitted from the station-side optical network unit and received by the subscriber-side optical network unit,
derive a physical quantity indicating a quality of the received signal from the signal-to-noise ratio acquired, and
set a power of a signal transmitted by the station-side optical network unit to a minimum power among powers at which the physical quantity derived indicates a predetermined quality; and
the subscriber-side optical network unit comprises
a second processor; and
a second storage medium having computer program instructions stored thereon, when executed by the second processor, perform to:
measure the signal-to-noise ratio of the received signal, and
transmit the signal-to-noise ratio measured to the station-side optical network unit.

5. The communication system according to claim 4, wherein in a case where a plurality of the subscriber-side optical network units is connected, the first processor sets the power of the signal transmitted by the subscriber-side optical network unit for each of the plurality of subscriber-side optical network units.

6. The communication system according to claim 4, wherein the first processor sets the power of the signal transmitted by the station-side optical network unit to the minimum power among the powers at which the physical quantity derived indicates the predetermined quality by reducing stepwise a power determined as an initial value.

7. A control method of a station-side optical network unit to be connected to a subscriber-side optical network unit, the control method comprising:
acquiring, from the subscriber-side optical network unit, a signal-to-noise ratio of a received signal transmitted from the station-side optical network unit and received by the subscriber-side optical network unit;
deriving a physical quantity indicating a quality of the received signal from the signal-to-noise ratio acquired; and
setting a power of a signal transmitted by the station-side optical network unit to a minimum power among powers at which the physical quantity derived indicates a predetermined quality.

8. A control method of a communication system including a subscriber-side optical network unit and a station-side optical network unit to be connected to the subscriber-side optical network unit, the control method comprising:
acquiring, by the station-side optical network unit, from the subscriber-side optical network unit, a signal-to-noise ratio of a received signal transmitted from the station-side optical network unit and received by the subscriber-side optical network unit;
deriving, by the station-side optical network unit, a physical quantity indicating a quality of the received signal from the acquired signal-to-noise ratio;
setting, by the station-side optical network unit, a power of a signal transmitted by the station-side optical network unit to a minimum power among powers at which the derived physical quantity indicates a predetermined quality;
measuring, by the optical network unit, the signal-to-noise ratio of the received signal, and
transmitting, by the optical network unit, the measured signal-to-noise ratio to the station-side optical network unit.

9. The station-side optical network unit according to claim 2, wherein the processor sets the power of the signal transmitted by the station-side optical network unit to the minimum power among the powers at which the physical quantity derived indicates the predetermined quality by reducing stepwise a power determined as an initial value.

10. The communication system according to claim 5, wherein the first processor sets the power of the signal transmitted by the station-side optical network unit to the minimum power among the powers at which the physical quantity derived indicates the predetermined quality by reducing stepwise a power determined as an initial value.
